(19) United States
(12) Patent Application Publication
(10) Pub. No.: US 2026/0303464 A1
(43) Pub. Date: Oct. 1, 2026

(54) METHOD AND APPARATUS FOR AUTOSCALING IN A WIRELESS COMMUNICATION SYSTEM

(71) Applicant: Samsung Electronics Co., Ltd., Suwon-si, Gyeonggi-do (KR)

(72) Inventors: Rasoul BEHRAVESH, Staines (GB); Refik Fatih USTOK, Staines (GB); Yue WANG, Staines (GB)

(21) Appl. No.: 19/478,545

(22) PCT Filed: Apr. 24, 2024
(86) PCT No.: PCT/KR2024/005535

§ 371 Date: Oct. 24, 2025

(30) Foreign Application Priority Data
Apr. 25, 2023 (GB) 2306074.2
Feb. 22, 2024 (GB) 2402526.4

(51) Int. Cl. H04L 41/0897; H04L 41/0686; H04L 41/0894; H04L 41/5025; H04L 41/5067; H04L 47/80; H04L 67/10; H04W 28/24

(52) U.S. Cl. CPC H04L 41/0897; H04L 41/0686; H04L 41/0894; H04L 41/5025; H04L 41/5067; H04L 47/808; H04L 67/10; H04W 28/24

(57) ABSTRACT

The disclosure relates to a 5G or 6G communication system for supporting a higher data transmission rate. According to an embodiment of the present disclosure there is provided a first entity in a network, the first entity comprising: a transceiver; at least one processor configured to: obtain first data from one or more second entities in the network, the first data comprising network related data; and perform hybrid scaling for a workload in the network based on the first data, wherein the hybrid scaling comprises a first type of scaling and a second type of scaling different to the first type of scaling. According to another embodiment there is provided a method of a first entity in a network, the method comprising: obtaining first data from one or more second entities in the network, the first data comprising network related data; and based on the first data, performing hybrid scaling for a workload in the network, wherein the hybrid scaling comprises a first type of scaling and a second type of scaling different to the first type of scaling.

### CROSS-REFERENCE TO RELATED APPLICATION(S)

This application is a U.S. National Stage application under 35 U.S.C. § 371 of an International application number PCT/KR2024/005535, filed on Apr. 24, 2024, which is based on and claims priority of a British patent application number 2306074.2, filed on Apr. 25, 2023, in the Great Britain Intellectual Property Office, and of a British patent application number 2402526.4, filed on Feb. 22, 2024, in the Great Britain Intellectual Property Office, the disclosure of each of which is incorporated by reference herein in its entirety.

### TECHNICAL FIELD

Certain examples of the present disclosure relate to methods, apparatus and/or systems for performing autoscaling in a wireless communication system. In particular, certain examples relate to methods, apparatus and/or systems for performing hybrid autoscaling of one or more instances in the network to adjust resources allocated to a corresponding task or workload. Further, certain examples relate to methods, apparatus and/or systems where the hybrid autoscaling includes a combination of vertical scaling and horizontal scaling, where the network is a cloud-native 5G, B5G or 6G network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless or mobile (cellular) communications networks in which a mobile terminal (e.g., user equipment (UE), such as a mobile handset) communicates via a radio link with a network of base stations, or other wireless access points or nodes, have undergone rapid development through a number of generations. The 3rd Generation Partnership Project (3GPP) design, specify and standardise technologies for mobile wireless communication networks. Fourth Generation (4G) and Fifth Generation (5G) systems (5GS) are now widely deployed, while beyond 5G (B5G) and 6G systems are being considered.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies B5G systems, such as 6G, are currently being considered and developed, and are expected to at least partly build on 5G systems.

In recent years, autonomous systems that incorporate machine learning solutions have become more prevalent in telecommunication networks, performing tasks such as prediction, planning, control, etc. These systems are different from conventional software components and present novel challenges and risks that may not be manageable through traditional software engineering practices. A reason for this difference is that the logic of these machine learning (ML) solutions is not defined by source code or specifications, but rather it is determined by the training process, the training data, and the input data at inference time.

New frameworks and architectures are being developed as part of 5G network (and beyond, such as 6G networks) in order to increase the range of functionality and use cases available through 5G networks.

5G and beyond networks, such as 6G, have been promising to revolutionize the way mobile networks are designed. Compared to the previous generations of mobile communications, 5G and 6G networks are expected to support a significantly wider scope of use cases with stringent requirements in terms of latency, bandwidth, and coverage. Aiming to support such use cases, significant improvements may need to be done in the network architecture and the way network is managed. A high degree of flexibility may be required of mobile networks, including 5G and future networks such as 6G, so as, for example, to meet the dynamicity of the work loads, to cope with complexity of the network itself, and to cope with future changes in the network. Different technological solutions have been employed across technological domains of 5G networks in order to meet the promised Key Performance Indicators (KPIs).

Both Radio Access Network (RAN) and core network (CN) have undergone a radical change in the 5G network, compared to previous networks. For example, the current design of the 5G Core (5GC) has adopted a service based architecture, where Network Functions (NFs) are responsible to provide specific services (which may be referred to as ‘microservices’) to other NFs in the system and similarly consume service(s) from other NFs in the system. Moreover, 5GC introduces the concept of Control Plane and User Plane separation (CUPS), where a clear distinction between control plane (CP) and user plane (UP) layers has been made. Further to this enabling technologies, cloud-native technologies have been widely adopted in 5GC in order to provide flexibility, availability and elasticity in the network.

In a cloud-native 5GC, for example, NFs may be deployed as light-weight containerized microservices managed dynamically. Containerization allows bundling NFs logic and its dependencies with minimum overhead as a standalone application, making it a viable solution for the 5G and 6G networks, where flexibility, scalability and availability are of high, if not most, importance. Cloud-native is a widely accepted software approach for building, deploying and managing applications in the cloud computing environments. In this regard, different cloud-native container management and orchestration tools and technologies have emerged in the cloud domain to provide management frameworks in scale. Docker Swarm, Apache Mesos, and Kubernetes (K8s) are some examples of well-practiced container management tools in the cloud computing environments.

Despite significant advancement in the cloud-native orchestration technologies, there is a failure to capture all unique characteristics, such as networking load and NF-related metrics of telecommunications domain, because existing container management tools for cloud computing environments are not natively designed for such mobile network environments (e.g., cloud-native 5GC). Thus, incorporating new features and defining new interfaces for the existing tools is necessary to provide viable solutions for mobile networks environments. Responsiveness to network dynamics and contexts is one of the major issues when cloud-native orchestration tools are employed in the telecommunications domain.

### DISCLOSURE OF INVENTION

### Technical Problem Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

According to an aspect of the present disclosure, there is provided a first entity in a network, the first entity comprising: a receiver; at least one processor configured to: obtain first data from one or more second entities in the network, the first data comprising network related data; and perform hybrid scaling for a workload in the network based on the first data, wherein the hybrid scaling comprises a first type of scaling and a second type of scaling different to the first type of scaling. According to another aspect, there is provided a first entity in a network, the first entity comprising: a receiver; at least one processor configured to: obtain first data from one or more second entities in the network, the first data comprising network related data; and determine whether to perform hybrid scaling for a workload in the network based on the first data, wherein the hybrid scaling comprises a first type of scaling and a second type of scaling different to the first type of scaling. There now follow a number of examples which can apply for either or both of these aspects.

According to an example, the at least one processor is configured to: identify first information based on the first data, wherein the first information comprises one or more of a target for scaling in the network, information on an issue in the network or information on a cause of the issue in the network; and perform the hybrid scaling based on the first information.

According to an example, the at least one processor is configured to: identify first information based on the first data, wherein the first information comprises one or more of a target for scaling in the network, information on an issue in the network or information on a cause of the issue in the network; and determine to perform the hybrid scaling based on the first information.

According to an example, the at least one processor is configured to: determine a scaling policy for performing the hybrid scaling; and assist execution of the scaling policy in the network. For example, execution of the scaling policy results in the performing of hybrid scaling.

According to an example, the at least one processor is configured to: if it is determined to perform hybrid scaling, determine a scaling policy for performing the hybrid scaling; and assist execution of the scaling policy in the network. For example, execution of the scaling policy results in performing the hybrid scaling.

According to an example, the scaling policy includes information on a configuration of the network, the configuration indicating to perform the hybrid scaling on one or more network function (NF) or instance associated with the workload.

According to an example, the at least one processor is configured to: provide one or more network function ID corresponding to the one or more NF to be scaled and an indication of a portion of the first data which triggers the performing of the hybrid scaling; and determine the scaling policy based on the one or more network function ID and the portion of the first data.

According to an example, the at least one processor is configured to: provide one or more network function ID corresponding to the one or more NF to be scaled and an indication of a portion of the first data which triggers the decision to perform the hybrid scaling; and determine the scaling policy based on the one or more network function ID and the portion of the first data.

According to an example, the at least one processor is configured to: perform the first type of scaling based on the scaling policy, and perform the second type of scaling based on the scaling policy; or transmit the scaling policy to a third entity in the network for execution in the network.

According to an example, the workload comprises one or more first instances; and wherein the scaling policy indicates to: perform the first type of scaling to add one or more second instances to the workload or to remove at least one of the one or more first instances from the workload; and perform the second type of scaling to modify resources for at least one of the added one or more first instances and/or at least one of the one or more second instances in the workload.

According to an example, the scaling policy indicates one or more of: resources for each of the one or more second instances; or to perform the second type of scaling by reducing or adding available CPU and/or memory resources for the at least one first instance or second instance.

According to an example, each added second instance, if any, and each first instance corresponds to a network function (NF) in the network.

According to an example, the scaling policy indicates to use the first type of scaling for instances corresponding to an NF among a first group of NFs, and to use the second type of scaling for instance(s) corresponding to an NF among a second group of NFs.

According to an example, the second group of NFs comprise one or more NF's which store user equipment (UE) context and exchange state information for UEs.

According to an example, the first group of NFs comprises an Access and Mobility Management (AMF) and/or a Session Management Function (SMF), and the second group of NFs comprises a Unified Data Repository (UDR) and/or a Unified Data Management (UDM).

According to an example, the scaling policy is for modifying resource allocation in the network to provide a specific Quality of Experience (QoE) or service level agreement (SLA).

According to an example, the at least one processor is configured to: perform the hybrid scaling additionally based on an objective stored at the first entity or received from a fourth entity in the network.

According to an example, the at least one processor is configured to: determine whether to perform the hybrid scaling additionally based on an objective stored at the first entity or received from a fourth entity in the network.

According to an example, the first data comprises at least one of pod level metrics, load prediction, network metrics, network function metrics or computer data layer metrics.

According to an example, the at least one processor is configured to obtain the first data by combining data received from each of the one or more second entities.

According to an example, the first data is stored in one or more tables, the one or more tables being arranged to indicate a time or time period corresponding to pieces of data included in the first data.

According to an example, at least part of the first data comprises one or more of UERegistrationSuccess rate, available computing resources, transport link configurations, pod level computing resources and number of registration requests; and wherein the at least part of the first data is obtained from one second entity among the one or more second entities.

According to an example, the first type of scaling is horizontal scaling, the second type of scaling is vertical scaling, and the hybrid scaling is an autoscaling method.

According to an example, the first entity comprises a plurality of sub-entities; wherein a first sub-entity is configured to obtain the first data; wherein a second sub-entity is configured to perform the hybrid scaling.

According to an example, the at least one processor is configured to: update the obtained first data by continually obtaining new data from the one or more second entities; and continually determine whether to re-perform the hybrid scaling for the workload based on the updated first data.

According to an example, the at least one processor is configured to: generate a network topology for the network and a compute topology for the workload; and perform the hybrid scaling based also on the generated network topology and the generated compute topology.

According to an example, the at least one processor is configured to: generate a network topology for the network and a compute topology for the workload; and determine whether to perform the hybrid scaling based also on the generated network topology and the generated compute topology.

According to an example, one or more of: the network is a 4th Generation (4G) network, a 5th Generation (5G) network, a Beyond 5G (B5G) network, or a 6th Generation (6G) network; the workload is implemented in or managed by a cloud computing environment, wherein optionally the cloud computing environment is Docker Swarm, Apache Mesos or Kubernetes; the workload is a specific application in the network or a core network (CN) NF; the first entity includes one or more of a data mapper, a reasoner, a scaler or an orchestrator; the cloud computing environment comprises the orchestrator; and the one or more second entities include one or more: virtual entity, physical entity.

According to another aspect, there is provided a method of a first entity in a network, the method comprising: obtaining first data from one or more second entities in the network, the first data comprising network related data; and based on the first data, performing hybrid scaling for a workload in the network, wherein the hybrid scaling comprises a first type of scaling and a second type of scaling different to the first type of scaling. According to another aspect, there is provided a method of a first entity in a network, the method comprising: obtaining first data from one or more second entities in the network, the first data comprising network related data; and based on the first data, determining whether to perform hybrid scaling for a workload in the network, wherein the hybrid scaling comprises a first type of scaling and a second type of scaling different to the first type of scaling. There now follow a number of examples which can apply for either or both of these aspects.

According to an example, the method comprises: identifying first information based on the first data, wherein the first information comprises one or more of a target for scaling in the network, information on an issue in the network or information on a cause of the issue in the network; and performing the hybrid scaling based on the first information.

According to an example, the method comprises: identifying first information based on the first data, wherein the first information comprises one or more of a target for scaling in the network, information on an issue in the network or information on a cause of the issue in the network; and determining to perform the hybrid scaling based on the first information.

According to an example, the method comprises: determining a scaling policy for performing the hybrid scaling; and assisting execution of the scaling policy in the network. For example, execution of the scaling policy results in the performing of hybrid scaling.

According to an example, the method comprises: if it is determined to perform hybrid scaling, determining a scaling policy for performing the hybrid scaling; and assisting execution of the scaling policy in the network. For example, execution of the scaling policy results in performing the hybrid scaling.

According to an example, the scaling policy includes information on a configuration of the network, the configuration indicating to perform the hybrid scaling on one or more network function (NF) or instance associated with the workload.

According to an example, the method comprises: providing one or more network function ID corresponding to the one or more NF to be scaled and an indication of a portion of the first data which triggers the performing of the hybrid scaling; and determining the scaling policy based on the one or more network function ID and the portion of the first data.

According to an example, the method comprises: performing the first type of scaling based on the scaling policy, and performing the second type of scaling based on the scaling policy; or transmit the scaling policy to a third entity in the network for execution in the network.

According to an example, the workload comprises one or more first instances; and wherein the scaling policy indicates to: perform the first type of scaling to add one or more second instances to the workload or to remove at least one of the one or more first instances from the workload; and perform the second type of scaling to modify resources for at least one of the added one or more first instances and/or at least one of the one or more second instances in the workload.

According to an example, the scaling policy indicates one or more of: resources for each of the one or more second instances; or to perform the second type of scaling by reducing or adding available CPU and/or memory resources for the at least one first instance or second instance.

According to an example, each added second instance, if any, and each first instance corresponds to a network function (NF) in the network.

According to an example, the scaling policy indicates to use the first type of scaling for instances corresponding to an NF among a first group of NFs, and to use the second type of scaling for instance(s) corresponding to an NF among a second group of NFs.

According to an example, the second group of NFs comprise one or more NF's which store user equipment (UE) context and exchange state information for UEs.

According to an example, the first group of NFs comprises an Access and Mobility Management (AMF) and/or a Session Management Function (SMF), and the second group of NFs comprises a Unified Data Repository (UDR) and/or a Unified Data Management (UDM).

According to an example, the scaling policy is for modifying resource allocation in the network to provide a specific Quality of Experience (QoE) or service level agreement (SLA).

According to an example, the method comprises: performing the hybrid scaling additionally based on an objective stored at the first entity or received from a fourth entity in the network.

According to an example, the method comprises: determining whether to perform the hybrid scaling additionally based on an objective stored at the first entity or received from a fourth entity in the network.

According to an example, the first data comprises at least one of pod level metrics, load prediction, network metrics, network function metrics or computer data layer metrics.

According to an example, the method comprises obtaining the first data by combining data received from each of the one or more second entities.

According to an example, the first data is stored in one or more tables, the one or more tables being arranged to indicate a time or time period corresponding to pieces of data included in the first data.

According to an example, at least part of the first data comprises one or more of UERegistrationSuccess rate, available computing resources, transport link configurations, pod level computing resources and number of registration requests; and wherein the at least part of the first data is obtained from one second entity among the one or more second entities.

According to an example, the first type of scaling is horizontal scaling, the second type of scaling is vertical scaling, and the hybrid scaling is an autoscaling method.

According to an example, the first entity comprises a plurality of sub-entities; wherein a first sub-entity is configured to obtain the first data; wherein a second sub-entity is configured to perform the hybrid scaling.

According to an example, the first entity comprises a plurality of sub-entities; wherein a first sub-entity is configured to obtain the first data; wherein a second sub-entity is configured to determine whether to perform the hybrid scaling.

According to an example, the method comprises: updating the obtained first data by continually obtaining new data from the one or more second entities; and continually determining whether to re-perform the hybrid scaling for the workload based on the updated first data.

According to an example, the method comprises: generating a network topology for the network and a compute topology for the workload; and performing the hybrid scaling based also on the generated network topology and the generated compute topology.

According to an example, the method comprises: generating a network topology for the network and a compute topology for the workload; and determining whether to perform the hybrid scaling based also on the generated network topology and the generated compute topology.

According to an example, one or more of: the network is a 4th Generation (4G) network, a 5th Generation (5G) network, a Beyond 5G (B5G) network, or a 6th Generation (6G) network; the workload is implemented in or managed by a cloud computing environment, wherein optionally the cloud computing environment is Docker Swarm, Apache Mesos or Kubernetes; the workload is a specific application in the network or a core network (CN) NF; the first entity includes one or more of a data mapper, a reasoner, a scaler or an orchestrator; the cloud computing environment comprises the orchestrator; and the one or more second entities include one or more: virtual entity, physical entity.

According to another aspect, there is provided a computer readable storage medium comprising instructions which, when executed by at least one processor of a computer, cause the computer to perform a method according to any of the aspects or examples give above.

Other aspects, advantages, and salient features of the disclosure will become apparent to those skilled in the art from the following detailed description taken in conjunction with the accompanying drawings.

### BRIEF DESCRIPTION OF DRAWINGS

Embodiments/examples of the present disclosure are further described hereinafter with reference to the accompanying drawings, in which:

FIG. 1A schematically illustrates an example of a horizontal pod autoscaler.

FIG. 1B schematically illustrates an example of a vertical pod autoscaler.

FIG. 2 schematically illustrates a system architecture according to various examples of the present disclosure.

FIG. 3 is a sequence diagram illustrating a method according to various examples of the present disclosure.

FIG. 4 schematically illustrates a system architecture according to various examples of the present disclosure.

FIG. 5 schematically illustrates part of a core network;

FIG. 6 schematically illustrates different scaling methods applied in a particular use-case, according to various examples of the present disclosure.

FIG. 7 is a block diagram illustrating an example structure of a network entity in accordance with certain examples of the present disclosure.

### MODE FOR INVENTION

The following description of examples of the present disclosure, with reference to the accompanying drawings, is provided to assist in a comprehensive understanding of certain examples of the present disclosure. The description includes various specific details to assist in that understanding but these are to be regarded as merely exemplary. Accordingly, those of ordinary skill in the art will recognize that various changes and modifications of the examples described herein can be made without departing from the scope of the invention or disclosure.

The same or similar components may be designated by the same or similar reference numerals, although they may be illustrated in different drawings. Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but are merely used to enable a clear and consistent understanding of the disclosure.

Throughout the description of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description of this specification, the singular form, for example “a”, “an” and “the”, encompasses the plural unless the context otherwise requires. For example, reference to “an object” includes reference to one or more of such objects.

Throughout the description, the expression “at least one of A, B and/or C” (or the like), the expression “and/or” and the expression “one or more of A, B and/or C” (or the like) should be seen to separately include all possible combinations, for example: A, B, C, A and B, A and C, A and B and C. As used herein, terms such as “1st” and “2nd,” or “first” and “second” may be used to simply distinguish a corresponding component from another, and does not limit the components in other aspect (e.g., importance or order).

Throughout the description of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment or example are to be understood to be applicable to any other aspect, embodiment or example described herein unless incompatible therewith.

Certain examples of the present disclosure provide methods, apparatus and/or systems for performing autoscaling in a network. In particular, certain examples relate to methods, apparatus and/or systems for performing hybrid autoscaling of one or more instances in the network to adjust resources allocated to a corresponding task or workload. Further, certain examples relate to methods, apparatus and/or systems where the hybrid autoscaling includes a combination of vertical scaling and horizontal scaling, where the network is a cloud-native 5G, B5G or 6G network.

The following examples are applicable to, and use terminology associated with, 3GPP 4G (e.g., LTE) and/or 5G (e.g., NR). However, the skilled person will appreciate that the techniques disclosed herein are not limited to these examples or to 3GPP 4G (e.g., LTE) and/or 5G (e.g., NR), and may be applied in any suitable system or standard, for example one or more existing and/or future generation wireless communication systems or standards (e.g., B5G, 5G-Advanced, 6G etc.). The skilled person will appreciate that the techniques disclosed herein may be applied in any existing or future releases of 3GPP 4G (e.g., LTE) and/or 5G (e.g., NR) and/or 5G Advanced and/or 6G, and/or (3GPP Release 17, 18, 19, 20, etc.) or any other relevant standard. For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

Furthermore, the following also applies to the present disclosure:

The terms functionality/use-case/configuration/scenario/site may be used interchangeably.

The terms model and model functionality may be used interchangeably.

This disclosure also apply to non-3GPP entities.

The concepts, proposals, solutions, methods, embodiments, figures, and/or examples, presented in this disclosure, would apply to various type of communication systems, such as 4G, 4G-Advanced, 5G, 5G-Advanced, and 6G. Moreover, the above may also apply (in full or part or modified) to systems of Non-Terrestrial Networks (NR-NTN and/or IoT-NTN and/or UAV, etc.), in addition to Terrestrial Networks (TN).

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present disclosure is not limited to the specific examples disclosed herein. For example:

The techniques disclosed herein are not limited to 3GPP 4G or 5G or 5GAdvanced and also apply to B5G and 6G systems.

One or more entities in the examples disclosed herein may be replaced with one or more alternative entities performing equivalent or corresponding functions, processes or operations.

One or more of the messages in the examples disclosed herein may be replaced with one or more alternative messages, signals or other type of information carriers that communicate equivalent or corresponding information.

One or more further elements, entities and/or messages may be added to the examples disclosed herein.

One or more non-essential elements, entities and/or messages may be omitted in certain examples.

The functions, processes or operations of a particular entity in one example may be divided between two or more separate entities in an alternative example.

The functions, processes or operations of two or more separate entities in one example may be performed by a single entity in an alternative example.

Information carried by a particular message in one example may be carried by two or more separate messages in an alternative example.

Information carried by two or more separate messages in one example may be carried by a single message in an alternative example.

The order in which operations are performed may be modified, if possible, in alternative examples.

The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g., a network) comprising one or more such apparatuses/devices/network entities, and/or a method therefor.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, example and/or embodiment disclosed herein. Certain embodiments of the present disclosure provide a machine-readable storage storing such a program.

A network according to one or more of the examples disclosed herein may include one or more of a Network Data Analytics Function (NWDAF) entity, an Access and Mobility Management Function (AMF) entity, a Session Management Function (SMF) entity, a Network Slice Selection Function (NSSF) entity, a Network Repository Function (NRF) entity, Application Function (AF) entity, and an Operation and Maintenance (OAM) entity. The network may include one or more Service Consumers (including one or more of the entities mentioned above and/or one or more other entities) that receive analytics from NWDAF. The skilled person will appreciate that a network may omit one or more of the entities mentioned above and/or may comprise one or more additional entities.

As mentioned above, existing cloud-native orchestration technologies fail to capture some unique characteristics of a telecommunications domain. Further, responsiveness to network dynamics and contexts is a significant factor to consider when cloud-native orchestration tools are employed in the telco domain. For example, current orchestration tools such as K8s are completely reliant on computing resource usage for autoscaling operations. K8s, through monitoring agents, intermittently measure resource utilization (CPU and Memory) of pods (where a pod is an execution unit in K8s which may encapsulate one or more applications; e.g., from [3], a pod is a group of one or more containers, with shared storage and network resources, and a specification for how to run the containers) and worker nodes (where worker nodes are used to run containerized applications and handle networking to ensure traffic between applications, across the K8s cluster and from outside of the cluster, can be properly facilitated), and upon reaching a pre-defined threshold trigger scaling of pods. Although the present disclosure may refer to features which are specific to K8s, it will be appreciated that reference could instead be made to similar or analogous features of other cloud-native orchestration technologies. That is, the present disclosure considers a more general case than that of any specific orchestration technologies.

As stated, the current implementation of the K8s-which may be regarded as a standard for existing container orchestration-treats autoscaling in a reactive manner, meaning that a certain threshold in terms of resource utilization should be met before making any scaling decisions. However, this approach has some disadvantages when it comes to telecommunication domains, as most of services are latency sensitive and require services to be always available and reliable which also means ultra-low packet-loss in networks.

Horizontal Scaling (HS) and Vertical Scaling (VS) are two prominent, existing strategies of scaling in cloud environments.

HS is the method (or strategy) of increasing or decreasing application instances by adding or deleting a number of instances of the same pod upon meeting a certain condition in terms of computational resources in an act to meet the demand.

We now provide a brief description of various terms used herein, including workload, instance, pod, and deployment. Examples of a workload include a specific application in a system (e.g., 5GS), and core NFs such as AMF, SMF, PCF etc. An instance (as described further later), may be a container or a virtual machine configured to run a workload. A different number of instances may be run/executed depending on workload requirements. Pod is a Kubernetes terms used for a group of containers that are related and share the same networking and storage space. A pod encapsulates one or more containers together. A pod template is the manifest containing details about the pod that is to be run. For example, a pod template may typically contain information about the number of containers on that pod, the storage, CPU, and/or memory requirements and so on so forth. A pod template will be provided to the Kubernetes orchestrator to deploy the pod. A deployment is a name given to one or more pods that are related and work together to accomplish a workload. Deployments are management objects in Kubernetes and control the way pods behave in the cluster. For example, deployment controls how to update, scale, and/or terminate pods.

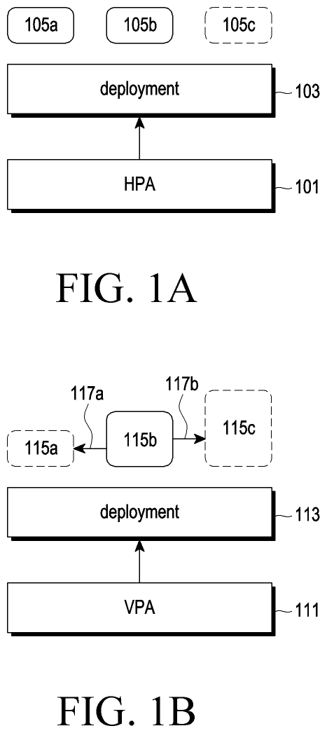

As shown in FIG. 1A, in the HS method, there is a default template, defining the base image configurations and scaling conditions among the others. HorizontalPodAutoscaler (HPA) 101 is the default autoscaling object in K8s, responsible for scaling in/out decisions for workload(s) in order to match the demand. According to [2], in K8s, a HorizontalPodAutoscaler automatically updates a workload resource (such as a deployment or StatefulSet), with the aim of automatically scaling the workload to match demand. In an example, horizontal scaling means deploying more pods in response to increased load. This is different from vertical scaling, which for K8s means, for instance, assigning more resources (for example: memory or CPU) to the pods that are already running for the workload. If the load decreases, and the number of pods is above the configured minimum, the HorizontalPodAutoscaler instructs the workload resource (the Deployment, StatefulSet, or other similar resource) to scale back down.

In the case of scale-out, one or more instances 105a, 105b, 105c (e.g. which may be NFs or VNFs) of the same workload are deployed (e.g., added to an existing environment or deployment 103) with the same configuration for all of them using a predefined pod template. For example, instance 105c may be added to the deployment of instance 105a and instance 105b if more resources are needed. While, in the case of scale-in, one or multiple of operating instances 105a, 105b, 105c (e.g., which may be NFs or VNFs) will be terminated (e.g., terminated in or removed from an existing environment or deployment 103). For example, instance 105c may be terminated if fewer resources are needed.

Each instance 105a, 105b, 105c may be considered to have an associated amount of physical resources, such as processing resources (e.g. number and/or speed of virtual CPU(s) (vCPU(s)) allocated to the instance 105a, 105b, 105c) and/or memory resources (e.g. a size of a virtual memory allocated to the instance 105a, 105b, 105c). As mentioned above, in the HS method the instances 105a, 105b, 105c have the same configuration, and so may each have the same associated resources (e.g., a same number of vCPU(s) and a same size of virtual memory allocated). To give a non-limiting example, each instance 105a, 105b, 105c may have 1 vCPU and 128 GB of virtual memory allocated.

HPA 101 may be configured to typically deploy scaled instances on different worker nodes aiming to increase availability of the whole deployment 103, e.g., by providing additional instances of the same workload with the same configuration. This is one of the primary advantages of the HS method. This scaling method usually comes with a smaller footprint in terms of physical resource utilization as the instances are fairly small and do not grow after initialization. Moreover, the HS method results in smaller size instances that can be easily packed on the bare metal servers (i.e. physical hardware).

As opposed to the HS, in the VS strategy, illustrated in FIG. 1B, the number of instances 115 (e.g., which may be NFs or VNFs) does not change with the scaling decisions.

In this scaling method, upon reaching a threshold, configured resources on a pod or an instance are increased/decreased. There are two types of VS operations called scale-up and scale-down. In the scale-up operation, the amount of physical resources e.g. number/speed of vCPU(s) and/or memory is increased. While in the case of scale-down, the already allocated resources are deducted on an instance. To give a non-limiting example, as schematically illustrated in FIG. 1B by the use of dashed lines and different sizes: instance 115b, shown centrally, could be scaled down (indicated by arrow 117a) to decrease the number of resources for this instance (e.g., scaling from initially being allocated 2 vCPU and 128 GB memory to instead be allocated 1 vCPU and 128 GB memory), with the scaled-down instance 115a shown on the left with a dashed outline (i.e., instance 115b is scaled down to result in instance 115a); or instance 115b, shown centrally, could be scaled up (indicated by arrow 117b) to increase the number of resources for the instance (e.g., scaling from initially being allocated 2 vCPU and 128 GB memory to 3 vCPU and 512 GB memory), with scaled-up instance 115c shown on the right with a dashed outline (i.e., instance 115b is scaled up to result in instance 115c).

As will be apparent, this approach has a lower availability compared to the HS approach (i.e., the availability of deployment 113 may be lower, overall, compared to that of deployment 103, because, for example, more instances can be added in the HS method). However, the VS method comes with many advantages of its own, such as allowing for customized scaling of CPU and Memory resources. The VS method allows increasing and/or decreasing resources independently without being necessary to increase and/or decrease both resources together. For example, in VS, a number of CPU(s) may be increased while memory size is maintained, or memory size may be increased while a number of CPU(s) is maintained, for the same instance 115a, 115b, 115c or across different instances 115a, 115b, 115c. Moreover, VS shows a better level of data consistency as the resized instances are usually placed on the same node.

As mentioned above, each of the HS and VS methods have some advantages and disadvantages depending on the scenario and application requirements. This proves that selecting any of these strategies alone does not lead to desired outcomes in every scenario. Therefore, a greater advantage can be made by using both of these strategies at the right moment according to the real-time network contexts. Accordingly, the present disclosure includes Hybrid Scaling methods which may incorporate the advantages of both of the aforementioned scaling methods (i.e. HS and VS) using a variety of sources of metrics including one or more of (but not limited to): computing metrics, pod level metrics, load prediction, network metrics and network function metrics. More specifically, certain examples of the present disclosure provide a data mapper component configured to collect or acquire different metrics from different components in the network and wrap the collected metrics in a table for use in reasoning to direct the hybrid scaling on the scaling decisions (e.g., in decisions regarding scaling in the network).

Accordingly, certain examples of the present disclosure enable hybrid scaling of virtualized network functions. The present disclosure includes a data mapper layer (or similar, e.g., a data mapper entity) to combine data from at least one component (e.g., different entities or components) in the network and to make the combined data a source or basis for directing (e.g., controlling) a hybrid scaling strategy. In various examples, the output of data mapper may be a table or a set of tables summarizing collected metrics, such as in a time series form. In which case, the table(s) is regarded as a reasoning source for the hybrid scaler component.

As will be apparent from the discussion of examples and embodiments within the scope of the present disclosure, the present disclosure may provide one of more of the following advantages:

A unique approach to scaling network functions in the next generation mobile networks by combining the benefits of horizontal and vertical scaling. This means that, for instance, the system is designed to scale, or be capable of scaling, by both adding more instances (horizontal scaling) as well as by increasing the resources of existing instances (vertical scaling). This hybrid approach may allow for better performance, cost efficiency, and/or reliability compared to traditional scaling strategies.

The collection of metrics from various different components in the network. In this regard, information is collected from different sources (e.g., different entities in the network, which may include both virtual and physical entities) comprising, for example, one or more of: bare metal worker nodes, network communication between nodes, network functions, and/or predictions about future networking and load status. Collecting these metrics enables operators to monitor and optimize network's performance in real-time, ensuring that resources are allocated efficiently, and services are delivered smoothly, particularly compared to a case where only computing metrics are used in autoscaling.

Aiding understanding of the different metrics collected by the system by providing a metric translation layer (or similar, e.g., a metric translating entity). This layer may act as a bridge or link between the different sources of data, allowing operators to analyze a unified, consolidated set of metrics that can be used to inform scaling decisions.

Providing greater flexibility to current orchestration tools like K8s. Specifically, various examples allow for customized scaling of network functions, which means that operators may adjust the resources allocated to a particular function based on its specific requirements according to the specific scenario in real time. This flexibility may enable operators to optimize their network for the unique demands of their services and customers.

Being easily adjustable based on network operator demands at each stage of operations. That is, various examples may be customized to meet changing needs over time, ensuring that the network is operating at peak efficiency at all times where possible. By allowing operators to adjust scaling parameters as needed, the system may be able to adapt to changing conditions and make sure that resources are allocated appropriately.

As stated earlier, 6G networks are expected to meet a significantly higher set of use case with different requirements. Meeting such requirements may demand a high degree of dynamicity in the network. Autoscaling of network functions is a key issue to consider, addressing how/when to increase/decrease network resources to satisfy service requirements. In this regard, various examples and embodiments of the present disclosure provide a new framework to address the problem of optimum autoscaling of network functions in an automated manner.

According to an example of the present disclosure, there is provided a network comprising a data mapper entity configured: to collect network related data (e.g., Network Metrics and NF Metrics), optionally along with computing data layer metrics, and to store the collected data in a table and/or a set of tables as time series data. E.g., the collected data may also be mapped; for instance, data corresponding to a particular time or time period which is collected from one source may be mapped to data corresponding to the same time or time period from another source. Collecting data in a time series manner may enable applying different data-driven machine learning (ML) models to capture the patterns of changes in the network configuration with respect to computing resource metrics, networking resource metrics, and/or network function specific metrics.

According to a further example, the network may further comprise a reasoning entity configured: to obtain (e.g., request, receive, acquire etc.) the table(s) from the data mapper entity; to identify (or determine, detect etc.) whether there is an issue in the network (e.g., based on the table(s) and/or a piece of the data included therein); and, if so, to identify (e.g., understand, determine etc.) a cause (e.g., root cause) of the identified issue.

According to a yet further example, the network may further comprise a scaling entity (e.g., hybrid scaling module) configured: to determine (e.g., decide, identify etc.) a scaling policy (such as an optimum scaling policy) of the Network Function(s); and to execute the scaling policy in a network orchestrator (e.g., a K8 (s) included in the network).

Certain examples of the present disclosure aim to provide systems, apparatus and/or methods that support hybrid scaling of NFs in virtualized environments of mobile networks. This may enable bridging of the gap between the two major scaling techniques, namely VS and HS. As a result, the hybrid scaling strategy will be able to strike a balance between these two scaling techniques depending on the scenario, service/NF requirements, and resources available in the network.

The present disclosure includes examples which offer a flexible system that follow an objective determined by the mobile network operator, which could be to increase network function availability, improve network resiliency, or optimize resource utilization. This way, the hybrid scaling technique will provide a tailor-made solution to address specific network demands, and optimize the utilization of resources.

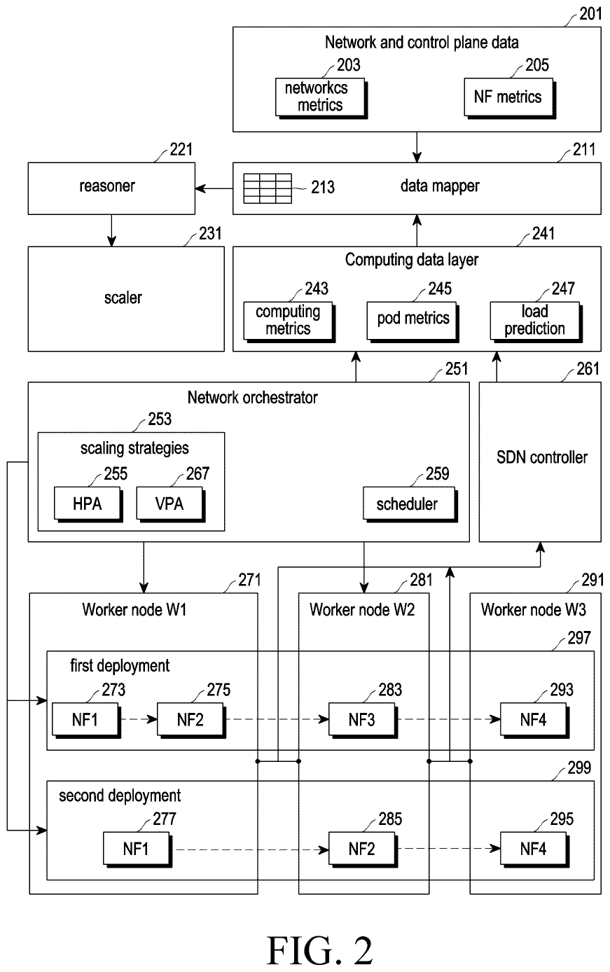

Various examples according to the present disclosure comprise several components/entities that enable hybrid scaling of network functions such as Core NF(s) and RAN NF(s), as illustrated in FIG. 2 which is discussed in more detail below. It is noteworthy that the system is not limited to the RAN and/or core network and can be applied to different domains of networks, e.g. as the 5G, B5G, 6G etc. networks evolve.

In short, various examples of the present disclosure may provide an enhanced network architecture and entities that support the hybrid scaling of NFs in virtualized environments of mobile networks. Various examples further enable solution(s) to a number of scenarios in the network where hybrid scaling will be needed or is desirable. Benefits include one or more of: optimizing resource utilization, improving network function availability, and enhancing network resiliency.

It will be appreciated that although the present disclosure often refers to the core network (e.g., CN entities, parts of the CN etc.), the examples of the present disclosure may also be extended to other domains of the network (e.g., RAN), as would be understood by a person skilled in the art. In other words, the present disclosure includes domain-agnostic versions of any more-specific (e.g., domain specific) example described herein. It is also understood that although the present disclosure may refer to particular scenarios and use cases, examples of the present disclosure can be generalized to other use cases and scenarios. e.g., providing the expected benefits/advantages.

FIG. 2 schematically illustrates an architecture of a scaling system in accordance with an example of the present disclosure. It will be appreciated that, although various components/entities are shown separately in FIG. 2, in various examples any two or more of the illustrated components may be combined. For example, two or more of data mapper 211, reasoner 221 and scaler 231 may be combined into a single component providing the functionality of the individual components.

FIG. 2 illustrates a number of network entities (e.g., components, layers etc) including: network and control plane data 201, computing data layer 241, network orchestrator 251, Software-Defined networks (SDN) controller 261, worker node W1 271, worker node W2 281 and worker node W3 291 (where each worker node may have an associated workload). These entities (which are described further below), although included in some examples of the present disclosure, may be omitted from other examples of the present disclosure, which focus instead on one or more of the data mapper 211, reasoner 221 and scaler 231.

Network and control plane data 201 may comprise network metrics 203 and NF metrics 205. Computing data layer 241 may comprise computing metrics 243, pod metrics 245 and load prediction 247. Network orchestrator 251, which may be K8(s) for example, may comprise scaling strategies 253, including HorizontalPodAutoscaler (HPA) 255 and VerticalPodAutoscaler (VPA) 257, and scheduler 259. Worker node W1 271 may comprise, as part of a first deployment 297, NF1 273 and NF2 275, and, as part of a second deployment 299, NF1 277. Worker node W2 281 may comprise, as part of the first deployment 297, NF3 283, and, as part of the second deployment 299, NF2 285. Worker node W3 291 may comprise, as part of the first deployment 297, NF4 293, and, as part of the second deployment 299, NF4 295.

The network orchestrator 251, e.g. under control of or in response to instruction from the scaler 231, may control scaling in the first deployment 297 and/or in the second deployment 299, via HSA 255 and/or VSA 257. For example, one or more worker node in the first deployment 297 and/or second deployment 299 may be scaled by a HS method (e.g., to add or remove additional instances, such as adding/removing a NF) and/or by a VS method (e.g., to add/remove resources from an instance(s), such as adding/removing resources from an NF).

FIG. 2 also illustrates connections/communication between the various entities. For example, connections between individual metrics in the network and controller plane data entity 201 and in the computing data layer 241 to the data mapper 211.

FIG. 2 also illustrates a data mapper 211 component/entity provided by examples of the present disclosure. The data mapper 211 may be configured to collect and combine data from one or more different elements/components in the network. In the example of FIG. 2, data mapper 211 is shown to receive metrics from network and control plane data 201 and/or from computing data layer 241. For example, the data mapper 211 may be responsible for combining metrics from the network, NF(s), computing hardware, pod, and load prediction, and to make the collected/combined metrics a source for reasoning (e.g., reasoning in relation to a scaling decision). The data mapper 211 may produce or provide a table 213 or multiple tables, a non-limiting example of which is shown in Table 1.

TABLE 1

| | | Available | transport link | Pod level | |
|---|---|---|---|---|---|
| | | computing | configurations | computing | |
| | | resources | (bandwidth, | resources | No. |
| | UERegistrationSuccess | (cpu, mem, | delay, packet | (cpu, mem, | registration |
| ime | (%) | stg) | loss) | stg) | request |
| s 1 | >100 | 10 vcpu, | 10 Gbps, 10 ms, | 1 vcpu, | 20 |
| | | 6 GB, | 0.00001 | 500 MB, | |
| | | 500 GB | | 10 GB | |
| s 2 | >100 | 10 vcpu, | 10 Gbps, 10 ms, | 1 vcpu, | 30 |
| | | 6 GB, | 0.00001 | 500 MB, | |
| | | 500 GB | | 10 GB | |
| s 3 | <100 | 10 vcpu, | 10 Gbps, 10 ms, | 1 vcpu, | 50 |
| | | 6 GB, | 0.00001 | 500 MB, | |
| | | 500 GB | | 10 GB | |

The table(s) may be used to make or facilitate reasoning about metrics, to detect an issue(s) and detect root cause(s) for a detected issue(s), and/or to identify source(s) of the network that need to be scaled in order to satisfy service level agreements (SLAs) of the end users.

For example, Table 1 is an example showing collected metrics for the Access and Mobility Management Function (AMF) in 5GC. Table 1 includes metrics specific to the function (i.e., the AMF) and some other metrics that are common among all NFs in the system. There are multiple metrics in the table, including UERegistrationSuccess rate, which is an important metric to assess performance of the AMF function. Other metrics included in the table may be the data gathered from the physical network including computing resources and/or communication resources on the computing nodes and/or communication links between these nodes. In certain example, pod level information may also be regarded as an important source for scaling decision makings to evaluate the memory and CPU utilization of a pod.

As can be seen in Table 1, upon increasing a number of UE Registration requests, the success rate of the requests drops (indicated by UERegistrationSuccess being less than 100% for time “ts 3”, in the third row of data). Using the information in the table, a source of the problem, potentially the main source, may be identified. For example, as the table may include information from all gathered metrics, a reasoner entity (such as described below) may identify the source of the problem/issue using the table.

This identifying (of an issue and/or a source of an identified issue) may be performed by another component in the network, which receives the table(s) (i.e., the collected and combined data) from the data mapper 211. For example, the system of FIG. 2 comprises a reasoner 221 component/entity configured to use the data in the table to detect the issue and understand a/the root cause of the issue. Furthermore, the reasoner 221 may be configured to instruct a scaling entity, such as scaler 231 in FIG. 2, to modify, e.g., optimize, a particular aspect of the resource allocations to reach the desired state of the service. In certain examples, the reasoner 221 may comprise an algorithm and/or AI model to detect whether there are any issues and, if so, to understand the root cause of such.

As mentioned, the system of FIG. 2 also shows a scaler 231, which may also be termed a hybrid scaling module. The scaler 231 is configured to enable, or support, customizable and flexible scaling optimization of network resources and services. The scaler 231 receives input from the reasoner 221 for use in making scaling decisions, for example with a view of modifying the resource allocations in the network (e.g., for a particular NF) to reach a desired state of service (e.g., a specific QoE). In various examples the scaler 231 may be composed of optimization algorithms and/or ML models to perform the optimization task.

As indicated above, functionality provided by two or more of data mapper 211, reasoner 221 or scaler 231 may be provided by a single component, if preferred. For example, a single entity may collect and combine data acquired from the network, NF(s), hardware, pod(s) and/or load prediction, and use the combined data to determine whether or not there is an issue in the network or system and, if so, identify one or more causes for such.

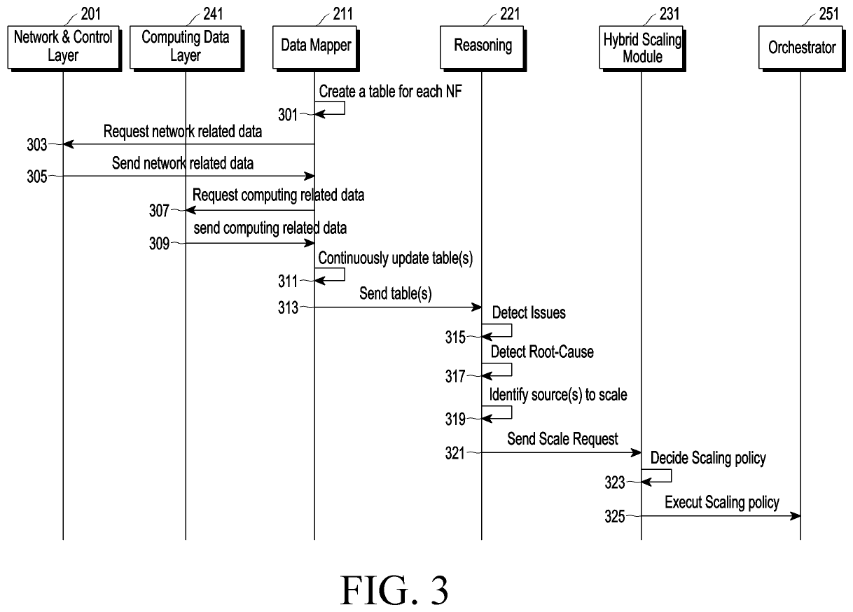

FIG. 3 illustrates a method according to an example of the present invention through a sequence diagram. The method may include operations performed by a network and control layer (e.g., network and control plane data 201 as shown in FIG. 2), a computing data layer (e.g., computing data layer 241 as shown in FIG. 2), a data mapper entity (e.g., data mapper 211 as shown in FIG. 2), a reasoning entity (e.g., reasoner 221 as shown in FIG. 2), a hybrid scaling module (e.g., scaler 231 as shown in FIG. 2), and an orchestrator (e.g., network orchestrator 251 as shown in FIG. 2).

It will be appreciated that various examples of the present disclosure include only a part of FIG. 3 (e.g., a subset of operations shown in FIG. 3), with other operations omitted. For instance, only operations in which one or more of the data mapper 211, reasoning entity 221 and/or hybrid scaling module 231 are directly involved may be included in an example. It will also be appreciated that the order of operations shown in FIG. 3 may be changed, unless it is the case that one operation depends on the output of another operation (or similar).

As shown in FIG. 3, in operations 303, 305, 307 and 309 the data mapper 211 may collect and store the metrics acquired from network and control layer 201 and computing data layer 241, for example in one or more tables (e.g., table 213).

For example, the data mapper 211 transmits, in operation 303, a request for metrics to the network and control layer 201. In operation 305, the network and control layer 201 may transmit the requested metrics (or at least a portion thereof) to the data mapper 211. In operation 303, the data mapper 211 may transmit a request for metrics to the computing data layer 241. In operation 309, the computing data layer 241 may transmit the requested metrics (or at least a portion thereof) to the data mapper 211. Optionally, in operation 301 the data mapper 211 may create a table for each NF (e.g., for each NF from which metrics are requested or for which associated metrics are requested) or any other network entity for which associated metrics may be collected.

It will be appreciated that operations 303 and 305 may be performed before, after or concurrently with operations 307 and 309. Also, operation 301 (if performed) may be performed before, after or concurrently with any of operations 303, 305, 307 and 309.

Operation 311 represents the data mapper 211 continuously updating the collected data (e.g., the table(s)), for example by continuing to request data (e.g., metrics) from the network and control layer 201 and/or the computing data layer 241 (or being provided with such data without request, such as may occur if, in operations 303 and 307, the data mapper 211 has requested continuous updating of the data/metrics (e.g., subscribing to a metric(s)). It will be appreciated that operation 311 is optional, and for example may not be performed in cases where continuous updating of the collected data is not essential.

The data in the table(s) may be passed, by the data mapper 211 (e.g., directly or indirectly) to the reasoning entity 221 to detect, understand and identify root cause of any issues that lead to SLA breach.

For example, in operation 313 the data mapper 211 transmits the collected data, e.g. the table(s), to the reasoning entity 221. In operation 315, the reasoning entity 221 detects/identifies whether one or more issues occur/exist in the system or network. This may be based on the received data. For example, an algorithm an/or AI model may analyse the collected data to identify whether any issues have arisen.

In operation 317, in the event that one or more issues are detected, the reasoning entity 221 may attempt to determine a root cause (or root causes) of each issue. This may also be based on the received data, as discussed above. For example, it may be determined that a workload requires additional instances or resources for existing instance(s) to be able to provide the required level of service (e.g., satisfy SLA(s), or that a workload does not require all of its existing resources such that one or more instances may be terminated or resources allocated to an instance may be reduced).

After identifying the reasoning, the reasoning entity 221 sends a scaling request to the hybrid scaling module 231.

For example, in operation 319, upon identifying the root cause(s), the reasoning entity 221 transmits a message to request scaling to the hybrid scaling module 231. The message (or scaling request) may include a network function ID (e.g., corresponding to the NF for which scaling is to be performed) and the row of the table that has caused the issue.

The hybrid scaling module 231 may use the data (e.g., reasoning data) received from the reasoning entity 221 to re-configure the network with an aim to meet the SLA requirements.

For example, in operation 323 the hybrid scaling module 231 determines, based on the data received from the reasoning entity 221 and one or more AI/ML models, a configuration of the network to address the identified issue(s) or to meet a requirement such as SLA requirements. The configuration may indicate to perform HS and/or VS on one or more NF or instance associated with a deployment or workload in the network. For example, the configuration may indicate to perform HS to add one or more instances or remove (terminate) one or more instances, and/or perform VS to add resources to one or more instance or to reduce resources for one or more instance.

In operation 325, the hybrid scaling module 231 may then communicate its determined network (re-)configuration to the orchestrator 251. For example, the hybrid scaling module 231 may transmit one or more messages or instructions to the orchestrator 251 to communicate changes to be made in the network, so as to achieved the determined configuration.

It will be appreciated that operations 315 to 325, in some examples, repeat, with the data being updated in operation 311, so as to continually reconfigure the network to provide, or aim to provide, optimal performance.

A short description of examples of various metric components that may be collected by the data mapper (such as data mapper 211 or otherwise in accordance with the present disclosure) is as follows:

### Network and Control Plane Data:

Network metrics (NW metrics): includes monitoring data on the communication links between computing nodes. For example, in contrast to the data mapper 211, K8s do not have any information about status and capacity of the links connecting the worker nodes in a cluster. This information can have a substantial effect on the orchestration decision making, especially when services are composed of multiple NFs which are deployed on different physical computing nodes and required to communicate with each other. A Software-defined Networking (SDN) controller may be provided to collect such data in the network. The SDN controller may forward the collected data to the data mapper 211, or to the computing data layer 241 so as to be provided to, or available to, the data mapper 211 (as illustrated in FIG. 2).

NF Metrics: Each NF in the 5GC has its own specific metrics that can be used as a valuable source of information for network management decision making. For example, having information about number of User Equipment (UEs) that are attached to a specific AMF or number of queries made for the Unified Data Repository (UDR) can be used making scaling decisions.

### Computing Data Layer:

Computing metrics (Comp. metrics): includes monitoring data on the computing nodes including but not limited to CPU capacity and memory capacity.

Pod Metrics: includes monitoring data on the resource utilization by a pod.

Load Prediction: This component is responsible for providing anticipated future requests in the network and resource demands for each of the predicted service requests. Having future load predictions enables a hybrid scaling module (e.g., scaler 231) to properly plan the network and provide services prior to being requested.

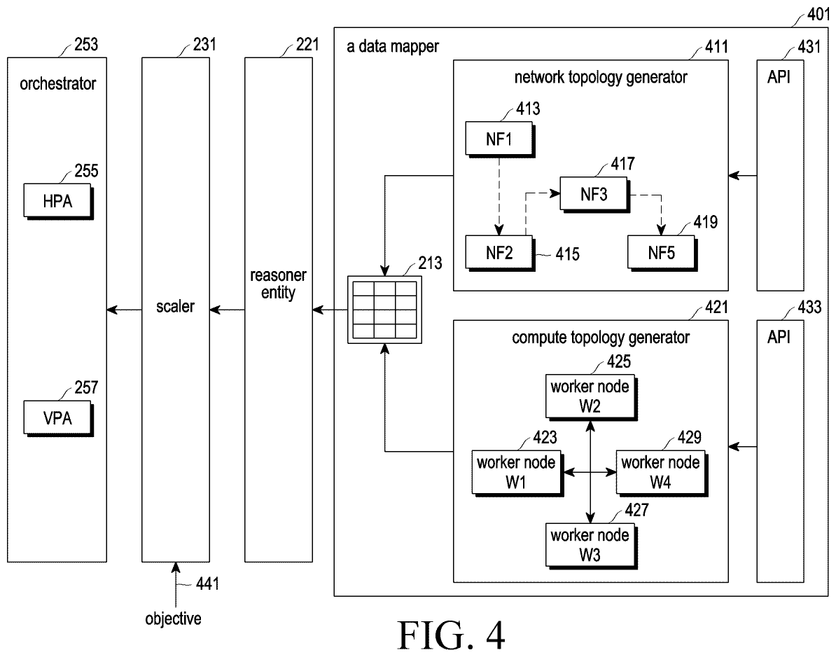

FIG. 4 schematically illustrates a system architecture according to various examples of the present disclosure.

In FIG. 4, a data mapper 401 (e.g., this may be data mapper 211 of FIG. 2) receives data from substrate network (including computing and network resources), topology of the network, and NFs. This data may be fed into the data mapper 401 through dedicated Application Programming Interfaces (APIs) for Services and Networks. For example, API 431 may be a network API server 431 configured to receive data from the NW layer and provide such to the data mapper 401, and API 433 may be a compute API server 433 configured to receive data from the compute layer and provide such to the data mapper 401. API 431 and API 433 may be included in data mapper 401 or provided separately to, but in communication with, data mapper 401.

After receiving the data, dedicated components in the data mapper 401 may generate topologies for both services/NFs and the substrate network.

Service topology defines the way NFs are connected to each other and what are hardware resource requirements from both computing and networking perspectives. In certain examples, services topologies may be represented as Service Function Chains (SFCs) as multiple NFs in the core network usually need to accomplish a specific service request. For example, a control pane procedure like UERegistration engages multiple NFs such as AMF, Session Management Function, and UDR. These NFs should be communicating with each other in a pre-defined order to complete a procedure. Therefore, core network procedures may be represented as SFCs. Note that various examples support requests (i.e. specific service requests) that include only one NF. NFs and connecting links are characterized by their resource demands in terms of CPU, Memory, No. of UEs, and so on.

To give an example, network topology generator 411 (which may be part of data mapper 401) generates a topology indicating NF1 413, NF2 415, NF3 417 and NF5 419, including one or more of: connections between the NFs, CPU for each NF, memory for each NF, number of UEs for each NF, bandwidth of each connection etc. Four NFs are shown in the non-limiting example of FIG. 4, but it will be appreciated that more or fewer NFs may be involved in achieving a service request or otherwise included in the topology.

Substrate network topology may be represented as a graph that includes worker nodes and communication links between them, or other suitable representation of this. Computing nodes and communication links may be characterized by their computing resources (e.g., CPU and Memory) and bandwidth, respectively. This information may enable the scaler 231 (which receives, e.g., as an input(s), the results, e.g., the output(s), of reasoner entity 221, which in turn receives the information from the data mapper 211 so as to identify any issues in the network and, if an issue(s) is present, to identify a root cause and instruct/request the scaler 231 to perform scaling as appropriate) to perform optimization (that is, determine a configuration/reconfiguration for the network), for example by using combinatorial/heuristic/Machine Learning (ML) techniques. Results of the scaling optimization process may trigger one or both of the optimization components (HS and VS) in the orchestrator (not shown in FIG. 4).

To give an example, compute topology generator 421 generates a topology indicating worker node W1 423, worker node W2 425, worker node W3 427 and worker node W4 429, including one or more of: connections between the worker nodes, CPU for each worker node, memory for each worker node, bandwidth of each connection etc. Four worker nodes are shown in the non-limiting example of FIG. 4, but it will be appreciated that more or fewer worker nodes may be involved in achieving a service request or otherwise included in the topology.

The data mapper 401 may generate or modify a table(s) 213 based on the service topology and the substrate network topology, thereby combining the information. The output of the data mapper 401 (e.g., table(s) 213) may be provided to a reasoning entity 221, which may function as disclosed in other examples found herein. The reasoning entity 221 may then transmit a request for scaling, or scaling instructions, to scaler 231. It will be appreciated that table(s) 213 may include other information in addition to that based on the service topology and substrate network topology; e.g., table(s) 213 may include information based on metrics obtained from one or more sources in the network (such as NFs).

Scaler 231 (e.g., a hybrid autoscaling module) may then function as disclosed in other examples herein, for example controlling scaling in the network such as by providing instructions or messages relating to scaling (e.g., one or more of VS and HS) to an orchestrator 253 which includes or at least manages HPA and VPA. Scaler 231 may also receive, as an input, an objective 441, for example an indication of cost, latency etc. This objective 441 may also be used (in combination with the output from reasoning entity 221) in making scaling decisions, determining how to (re-) configure the network etc. Accordingly, scaler 231 may follow different objectives such as minimisation of the cost in the network or minimisation of latency for services. Results of the optimization component, i.e., the scaler 231, can be in the form of scaling up, down, in, and out of a single function (e.g., NF) or multiple functions (e.g., NFs). The output of the scaler 231 should include the chosen scaling (VS and/or HS, and optionally other scaling methods) method as well as the selected pod(s) for scaling and worker node(s) on which scaling should happen.

As mentioned earlier, comparing to solely having VS or HS, the hybrid method of the present disclosure may lead to advantages in terms of resource utilization, number of VNF scaling operations in the network, and/or management overhead. When it comes to the resource utilization, VS usually has a lower resource consumption compared to HS as it simply allows adding or removing amount of dedicated resources to an entity (e.g., a pod) at run-time. This way, resources can be added or removed independently without the necessity of changing all resources together. Hybrid scaling in such scenarios may therefore increase flexibility in a system/network by allowing both of these scaling strategies to co-exist; allowing for a satisfactory level of resource utilization to be obtained, which may be lower than the horizontal scaling but higher than vertical scaling.

Having excessive number of virtualised network functions (VNFs) in the network induces a lot of management overheads; therefore, the scaling strategy needs to bring the management overhead as low as possible. On the other hand, higher number of instances of NFs in the network increase the service availability. While VS always tends to keep same number of instances and increase/decrease resources on the same instance, HS increases/decreases number of instances of the NF throughout the network. This is illustrated in Table 2, which summarises some of the advantages of each of VS and HS.

Accordingly, hybrid scaling methods according to the present disclosure may allow for the obtaining of the benefits of both VS and HS methods by make a compromise between availability and resource utilization.

TABLE 2

| | High | | | Specialized | Data |
|---|---|---|---|---|---|
| | availability | Elasticity | Scalability | upgrade | consistency |
| S | X | X | X | | |
| S | | | | X | X |

We now provide examples of use cases for various examples of the present disclosure.

As shown in Table 2, neither approach can be efficient in all cases. Various examples according to the present disclosure therefore provides a hybrid scaling method aiming to provide the advantages of both horizontal and vertical scaling methods.

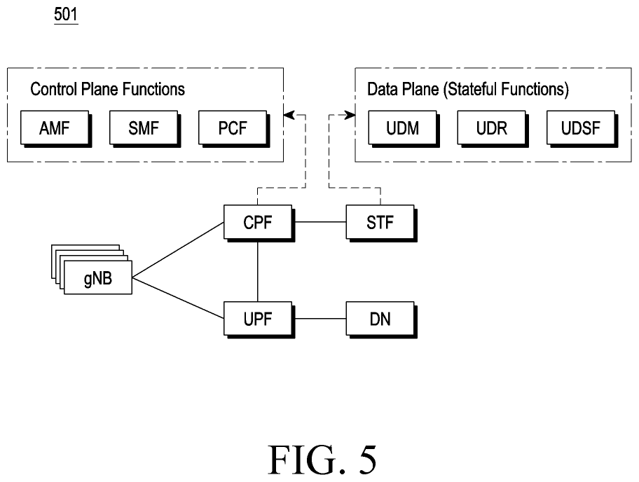

As a use case to demonstrate the advantages of the hybrid scaling method, consider the case of CN, where NFs are connected through a service bus. An example of the CN (or at least a part thereof) is illustrated in FIG. 5, showing network 501.

Each NF in the CN is responsible for a certain task and each particular task requires specific resources to accomplish a task. For instance, control plane NFs (CPF) such as Access and Mobility Management (AMF), Session Management Function (SMF) are usually stateless and do not require to store contexts locally. However, in the data layer there are functions such as Unified Data Repository (UDR) and Unified Data Management (UDM) that are stateful NFs (STF) and which store UE contexts and data about other functions in the core (e.g., which store states), and so which exchange (e.g., transmit and/or receive) state information.

Data consistency is an important aspect that requires careful consideration as incorrect handling of state data might cause service interruption for some users or induce additional (e.g., lots of, excessive) data transmissions and storage costs over the network. As evident from Table 2, HS is not a perfect solution for stateful NFs that demand high degree of data consistency, whereas VS is regarded as the better solution for stateful functions as VS does not need to exchange state(s) between different instances of the same function.

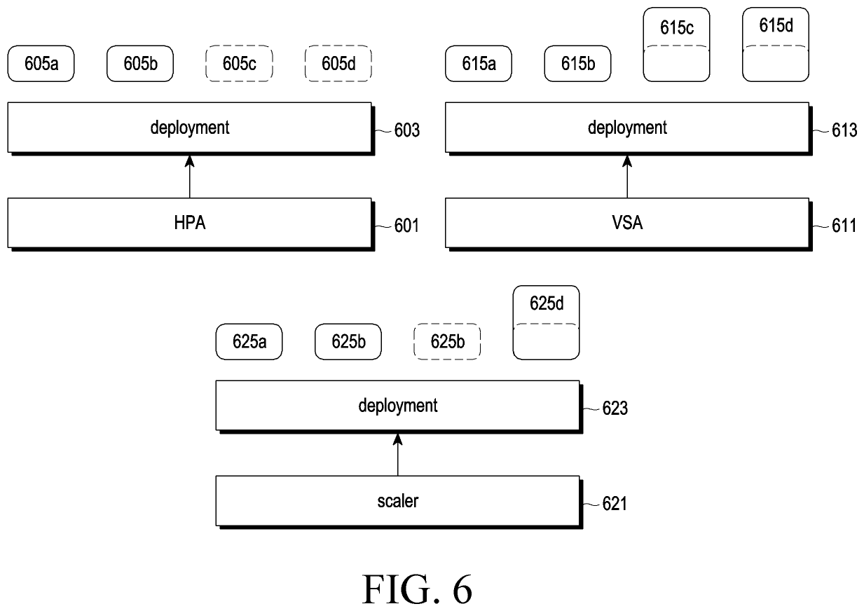

For example, as shown in FIG. 6, a hybrid scaling method as disclosed herein is capable of making different decisions based on the NFs characteristics.

FIG. 6 illustrates cases where HS is employed, VS is employed and where a hybrid method according to the present disclosure is employed. Each case considers the same NFs-AMF and UDR—but this should not be seen as limiting. It will be appreciated that the examples of FIG. 6 may be extended to cases with different NFs, such as SMF (or another stateless function) instead of AMF and/or with UDM or UDSF (or other STF).

For the HS case, HPA 601 controls scaling in deployment 603, which initially includes (or is associated with) instance 605a and instance 605b. Instance 605a is associated with (e.g., for) AMF, and instance 605b is associated with (e.g., for) UDR. As a result of scaling by HPA 601, instance 605c and instance 605d are added (illustrated by the dashed lines in FIG. 6 for instance 605c and instance 605d). Instance 605c is associated with (e.g., for) AMF, while instance 605d is associated with (e.g., for) UDR.

It may be the case that each instance 605a, 605b, 605c, 605d have the same resources (e.g., CPU and memory); that is, instance 605c and instance 605b are created with the same resources as instance 605a and instance 605b. To give a non-limiting example for illustrative purposes, each instance 605a, 605b, 605c, 605d may be allocated 1 vCPU and 128 GB of virtual memory.

For the VS case, VSA 611 controls scaling in deployment 613, which initially includes (or is associated with) instance 615a, instance 615b, instance 615c and instance 615d. Instance 615a and instance 615c are associated with (e.g., for) AMF, and instance 615b and instance 615d are associated with (e.g., for) UDR. Initially, it may be considered that each instance 615a, 615b, 615c, 615d is allocated the same resources (e.g., CPU and memory resources), or that a first set of resources are allocated to each instance 615a, 615b, 615c, 615d (where different instances may be allocated different amounts of resources). As a result of scaling, additional resources are added to instance 615c and instance 615d. For example, a reasoning entity (e.g., reasoning entity 221) or a scaler (e.g., scaler 231) determines to add resources to AMF and to UDR, for instance to improve provision of a corresponding service or to meet SDA(s). Accordingly, as illustrated in FIG. 6 by the dashed lines for instance 615c and instance 615d, resources have been added to these two instances.

It will be appreciated that different amounts of additional resources may be added to (or removed from, although this is not illustrated) different instances—although FIG. 6 shows instance 615c and instance 615d to be expanded by a similar amount, this should not be seen to indicate that the same additional resources must be added to each. To give a non-limiting example for illustrative purposes: instance 615a and instance 615b are each allocated 1 vCPU and 128 GB virtual memory, as were instance 615c and instance 615d initially; following scaling, instance 615c is allocated 3 vCPUs and 512 GB virtual memory, while instance 615d is allocated 2 vCPUs and 512 GB virtual memory. VS cannot add or remove instances from the deployment 613, however.

Turning now to the case where hybrid scaling according to an example of the present disclosure is used, scaler 621 (which may be regarded as a hybrid autoscaler, and which may function according to a scaler 231 (alone or in combination with other components, such as a reasoning entity 221) such as disclosed herein) controls scaling in deployment 623. As a result of scaling, deployment 623 includes (or is otherwise associated with) instance 625a, instance 625b, instance 625c and instance 625d. Instance 625a and instance 625c are associated with (e.g., for) AMF, and instance 625b and instance 625d are associated with (e.g., for) UDR.

For example, it may be that instances 625a, 625b and 625d have been included in deployment 623 initially. Following a scaling decision, instance 625c is added (to make additional resources available for AMF) and instance 625d is allocated more resources (to make additional resources available for UDF), as illustrated by the dashed lines for instances 625c, 625d in FIG. 6.

It will be appreciated that the hybrid scaling method allows for different instances to have different resources. To give a non-limiting example for illustrative purposes, instances 615a, 615b, 615c are allocated 1 vCPU and 128 GB virtual memory, while instance 615d is allocated 2 vCPU and 512 GB virtual memory. According to the hybrid method, instances may be added or removed, and resources may be added or reduced for individual instances.

In the given case of the CN, some network functions such as AMF and SMF are horizontally scaled, while functions in the data layer, such as UDR and UDM, are scaled vertically to keep the context local to the NFs on the same physical machine. In this scenario, the hybrid scaling approach may provide a high availability and scalability for control plane functions such as AMF and SMF (or other stateless functions) and at the same time may achieve a high degree of data consistency and customized scaling for data plane functions such as UDM, UDR, and UDSF (or stateful NFs).

Various examples of the present disclosure therefore provide the following advantages:
allowing network context(s) collection/storage/exchange/extraction in a cloud native 5G network, and in real time that facilitates AI-enabled orchestration of network function (as containers).
allowing proactive hybrid autoscaling; whereas existing methods are able to solely select of the pre-defined horizontal or vertical scaling.
providing apparatus, APIs and/o procedures for generating optimal customised metrics for one or multiple AI modules; whereas existing HPA metrics are not optimal, do not allow real-time collection and extraction of network data to generate the HPA metrics, and do not allow the use of the information in historical network context data.

When used in a cloud native network (e.g., cloud native 5G or 6G network), the following benefits may be provided by examples disclosed herein: reducing latency on autoscaling;
optimizing scaling by allowing both vertical and horizontal scaling at the same time;
allowing collection of different network, compute and service metrics.

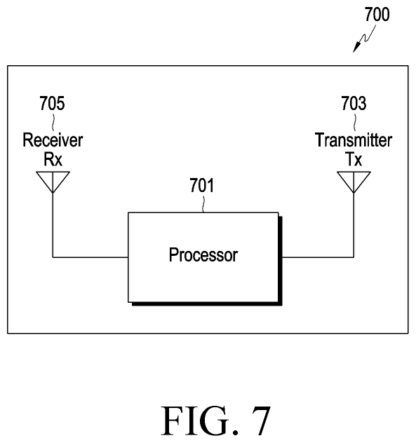

FIG. 7 is a block diagram of an exemplary apparatus, or network entity, that may be used in examples of the present disclosure. The skilled person will appreciate said entity may be implemented, for example, as a network element on a dedicated hardware, as a software instance running on a dedicated hardware, and/or as a virtualised function instantiated on an appropriate platform, e.g. on a cloud infrastructure.

The entity 700 comprises a processor (or controller) 701, a transmitter 703 and a receiver 705. The receiver 705 is configured for receiving one or more messages from one or more other network entities, for example as described above. The transmitter 703 is configured for transmitting one or more messages to one or more other network entities, for example as described above. The processor 701 is configured for performing one or more operations, for example according to the operations as described above. For example, one or more of data mapper 211, reasoning entity 221 or scaler 231 may be implemented by an entity according to entity 700.

According to an example of the present disclosure, there is provided a network (e.g., a 5G, B5G, or 6G cloud-native network) comprising a first entity, a second entity and a third entity, wherein the first entity is configured to collect data from one or more sources in the network and transmit the collected data to the second entity; wherein the second entity is configured to identify whether an issue exists in the network and, if so, determine a cause of the issue and/or a target for scaling; wherein the second entity is further configured to transmit an indication of the issue, the cause and/or the target to the third entity; and wherein the third entity is configured to control, based on the indication(s) received from the second entity, scaling of one or more instances running in the network by at least one of: adding/removing an instance to/from the one or more instances, or adding/reducing resources allocated to at least one of the one or more instances.

According to various examples, the data comprises first data collected from a network and control layer, and second data collected from a computing data layer.

According to various examples, the first data comprises network metrics (e.g., including monitoring data on the communication links between a plurality of computing nodes or entities included in the network) and/or network function metrics (e.g., information about a number of UEs attached to an AMF or a number of queries made for the UDR)).

According to various examples, the second data comprises computing metrics (e.g., including monitoring data on a plurality of computing nodes or entities included in the network), pod metrics (e.g., including monitoring data on resource utilization by a pod(s)), and/or load prediction.

According to various examples, the first entity is further configured to combine the data (e.g., the first data and the second data), for example into one or more tables; wherein the combined data (e.g., the one or more tables) is transmitted to the second entity as the collected data.

According to various examples, the first entity is configured to combine the data by generating a service topology based on the first data, wherein the service topology indicates connections (e.g., communication links) between at least one NF corresponding to at least one of the one or more instances. Optionally, in the service topology, the at least one NF and the connections between the at least one NF are characterised by their resource demands in the network (e.g., CPU resource requirements, memory resource requirements, number of UEs etc.).

According to various examples, the first entity is configured to combine the data by generating a substrate network topology based on the second data, wherein the substrate network topology indicates connections (e.g., communication links) between at least one worker node corresponding to at least one of the one or more instances (other than any instance which corresponds to an NF). Optionally, in the substrate network topology, the worker nodes and the connections are characterised by their computing resources (e.g., CPU and memory) and bandwidth, respectively.

According to various examples, the first entity is further configured to include the service topology and/or the substrate network topology in the one or more tables.

According to various examples, the first data is received via a first application programming interface (API) and the second data is received via a second API.

According to various examples, the first entity is configured to continuously update the collected data or the combined data with data received from the one or more sources.

According to various examples, the second entity is configured to identify whether there is an issue in the network and to detect the cause based on information included in the one or more tables received from the first entity.

According to various examples, the second entity employs an algorithm and/or an AI model to identify whether there is an issue in the network and to detect the cause.

According to various examples, the third entity is configured to decide a scaling policy based on the indication(s) received from the second entity, and to execute the scaling policy in combination with an orchestrator entity included in the network.

According to various examples, executing the scaling policy comprise transmitting the scaling policy to the orchestrator entity, or transmitting instructions formulated based on the scaling policy to the orchestrator entity.

According to various examples, the scaling policy is decided based on the target indicated by the second entity, the cause indicated by the second entity and, optionally, an objective provided to the third entity from elsewhere in the network.

According to various examples, the first entity is a data mapper, the second entity is a reasoner, and/or the third entity is a hybrid scaling module. Optionally, two or more of the first entity, the second entity or the third entity are combined into a single entity in the network.

According to various examples, there is provided a method including the operations of any of the networks disclosed above. For example, there is provided a method comprising: collecting, by a first entity in a network, data from one or more sources in the network; transmitting, by the first entity, the collected data to a second entity in the network; identifying, by the second entity, whether an issue exists in the network and, if so, determining a cause of the issue and/or a target for scaling; transmitting, by the second entity an indication of the issue, the cause and/or the target to a third entity in the network; and controlling, by the third entity based on the indication(s) received from the second entity, scaling of one or more instances running in the network by at least one of: adding/removing an instance to/from the one or more instances, or adding/reducing resources allocated to at least one of the one or more instances.

It will be appreciated that, in each example/embodiment/aspect etc. described above, one or more features or operations may be omitted, modified or moved (e.g., to change the order of the features or the operations), if desired and appropriate. Additionally, one or more features or operations from any example/embodiment may be combined with features or operations from any other example/embodiment. In particular, regardless of whether or not a pointer towards a combination of features/examples is found herein, the present disclosure should be considered to include all combinations of two or more of the embodiments, examples etc. disclosed herein, and all combinations of two or more of the features disclosed herein.

The techniques described herein may be implemented using any suitably configured apparatus and/or system. Such an apparatus and/or system may be configured to perform a method according to any aspect, embodiment or example disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment and/or aspect disclosed herein, and/or a machine-readable storage storing such a program. Still further, such programs may be conveyed electronically via any medium, for example a communication signal carried over a wired or wireless connection.

While the present disclosure has been shown, illustrated and described with reference to certain examples, it will be understood by those skilled in the art that various changes in form and detail may be made therein without departing from the scope of the disclosure.

The reader's attention is directed to all papers and documents which are filed concurrently with or previous to this specification in connection with this application and which are open to public inspection with this specification, and the contents of all such papers and documents are incorporated herein by reference.

1. A first entity in a network, the first entity comprising:
a transceiver; and
at least one processor configured to:
obtain first data from one or more second entities in the network,
the first data comprising network related data, and
perform hybrid scaling for a workload in the network based on the first data,
wherein the hybrid scaling comprises a first type of scaling and a second type of scaling different to the first type of scaling.

2. The first entity of claim 1, wherein the at least one processor is configured to:
identify first information based on the first data, wherein the first information comprises one or more of a target for scaling in the network, information on an issue in the network or information on a cause of the issue in the network, and
perform the hybrid scaling based on the first information.

3. The first entity of claim 1, wherein the at least one processor is configured to:
determine a scaling policy for performing the hybrid scaling, and assist execution of the scaling policy in the network.

4. The first entity of claim 3, wherein the scaling policy includes information on a configuration of the network, the configuration indicating to perform the hybrid scaling on one or more network function (NF) or instance associated with the workload.

5. The first entity of claim 4, wherein the at least one processor is configured to:
provide one or more network function ID corresponding to the one or more NF to be scaled and an indication of a portion of the first data which triggers the performing of the hybrid scaling, and
determine the scaling policy based on the one or more network function ID and the portion of the first data.

6. The first entity of claim 3, wherein the at least one processor is configured to:
perform the first type of scaling based on the scaling policy, and
perform the second type of scaling based on the scaling policy, or
transmit the scaling policy to a third entity in the network for execution in the network.

7. The first entity of claim 3, wherein the workload comprises one or more first instances; and
wherein the scaling policy indicates to:
perform the first type of scaling to add one or more second instances to the workload or to remove at least one of the one or more first instances from the workload, and
perform the second type of scaling to modify resources for at least one of the added one or more first instances and/or at least one of the one or more second instances in the workload.

8. The first entity of claim 7, wherein the scaling policy indicates one or more of:
resources for each of the one or more second instances, or to perform the second type of scaling by reducing or adding available CPU and/or memory resources for the at least one first instance or second instance.

9. The first entity of claim 7, wherein each added second instance, if any, and each first instance corresponds to a network function (NF) in the network.

10. The first entity of claim 9, wherein the scaling policy indicates to use the first type of scaling for instances corresponding to an NF among a first group of NFs, and to use the second type of scaling for instance(s) corresponding to an NF among a second group of NFs.

11. The first entity of claim 10, wherein the second group of NFs comprise one or more NF's which store user equipment (UE) context and exchange state information for UEs.

12. The first entity of claim 10, wherein the first group of NFs comprises an Access and Mobility Management (AMF) and/or a Session Management Function (SMF), and
wherein the second group of NFs comprises a Unified Data Repository (UDR) and/or a Unified Data Management (UDM).

13. The first entity of claim 3, wherein the scaling policy is for modifying resource allocation in the network to provide a specific Quality of Experience (QoE) or service level agreement (SLA).

14. The first entity of claim 1, wherein the at least one processor is configured to:
perform the hybrid scaling additionally based on an objective stored at the first entity or received from a fourth entity in the network.

15. A method of a first entity in a network, the method comprising:
obtaining first data from one or more second entities in the network, the first data comprising network related data; and
based on the first data, performing hybrid scaling for a workload in the network,
wherein the hybrid scaling comprises a first type of scaling and a second type of scaling different to the first type of scaling.
